(19) United States
(12) Patent Application Publication
(10) Pub. No.: US 2014/0216381 A1
(43) Pub. Date: Aug. 7, 2014

(54) INTERNAL COMBUSTION ENGINE

(71) Applicant: IMAGINEERING, INC., Kobe-shi (JP)

(72) Inventor: Yuji Ikeda, Kobe-shi (JP)

(73) Assignee: IMAGINEERING, INC., Kobe-shi (JP)

(21) Appl. No.: 14/156,061

(22) Filed: Jan. 15, 2014

Related U.S. Application Data
(63) Continuation of application No. PCT/JP2012/068009, filed on Jul. 13, 2012.

(30) Foreign Application Priority Data
Jul. 16, 2011 (JP) 2011-157285
Aug. 10, 2011 (JP) 2011-175393

(51) Int. Cl. F02P 23/04

(52) U.S. Cl. CPC F02P 23/045
USPC 123/143 B

(57) ABSTRACT

An internal combustion engine includes an internal combustion engine body formed with a combustion chamber, and an ignition device to ignite an air-fuel mixture in the combustion chamber. Repetitive combustion cycles, including the ignition of the air-fuel mixture by the ignition device and combustion of the air-fuel mixture, are executed. The internal combustion engine further has an electromagnetic (EM) wave-emitting device that emits EM radiation to the combustion chamber; a plurality of receiving antennas located on an outer circumference side of the zoning material that defines the combustion chamber; antenna which resonate with to the EM radiation that is emitted into the combustion chamber from the EM-wave-emitting device; and a control means which controls the EM-wave-emitting device such that the radiating antenna emits EM radiation into the combustion chamber while a flame caused by the ignition of the air-fuel mixture propagates.

### TECHNICAL FIELD

The present invention relates to an internal combustion engine that promotes combustion of an air-fuel mixture using electromagnetic (EM) radiation.

### BACKGROUND

An internal combustion engine that uses EM radiation to promote combustion of an air-fuel mixture is known. For example, JP 2007-113570A1 describes such an internal combustion engine.

The internal combustion engine described in JP 2007-113570A1 is equipped with an ignition device that generates plasma discharge by emitting microwaves in a combustion chamber before or after ignition of an air-fuel mixture. The ignition device generates local plasma using the discharge from an ignition plug such that plasma is generated in a high-pressure field, and develops this plasma using microwave radiation. The local plasma is generated in a discharge gap between the tip of an anode terminal and a ground terminal.

In a conventional internal combustion engine, plasma is generated near the ignition plug by microwave radiation emitted following the ignition of an air-fuel mixture. Thus, it was difficult to increase the propagation speed of a flame passing the center portion of the combustion chamber where the ignition plug is located. For example, the flame may not reach the wall face of the combustion chamber when the air-fuel mixture is lean and the propagation speed of the flame is slow, thereby emitting a substantial amount of unburned fuel.

### SUMMARY OF INVENTION

The first invention relates to an internal combustion engine including an internal combustion engine body formed with a combustion chamber, and an ignition device to ignite the air-fuel mixture in the combustion chamber. Repetitive combustion cycles, including ignition of the air-fuel mixture by the ignition device and combustion of the air-fuel mixture, are executed. The internal combustion engine comprises: an EM-wave-emitting device that emits EM radiation to the combustion chamber; a plurality of receiving antennas, located at the outer circumference of the zoning material that defines the combustion chamber; an antenna that resonates at the frequency of the EM radiation emitted into the combustion chamber from the EM-wave-emitting device; and a control means which controls the EM-wave-emitting device such that the radiating antenna emits EM radiation into the combustion chamber while the flame caused by ignition of the air-fuel mixture propagates.

### BRIEF DESCRIPTION OF THE DRAWINGS

FIG. 1 shows a longitudinal sectional view of an internal combustion engine according to one embodiment.

FIG. 2 shows a front view of the ceiling surface of the combustion chamber of the internal combustion engine according to one embodiment.

FIG. 3 shows a block diagram of an ignition device and an EM-wave-emitting device according to one embodiment.

FIG. 4 shows a front view of the top surface of a piston according to one embodiment.

FIG. 5 shows a longitudinal sectional view of a portion of an internal combustion engine with a different structure according to one embodiment.

FIG. 6 shows a front view of a top surface of a piston of the different structure according to one embodiment.

FIG. 7 shows a longitudinal sectional view of a portion of an internal combustion engine according to the second modification.

FIG. 8 shows a longitudinal sectional view of a portion of an internal combustion engine according to the third modification.

FIG. 9 shows a longitudinal sectional view of a portion of an internal combustion engine according to the fourth modification.

FIG. 10 shows a longitudinal sectional view of a portion of an internal combustion engine according to the sixth modification.

FIG. 11 shows a longitudinal sectional view of a portion of an internal combustion engine according to the seventh modification.

FIG. 12 shows a longitudinal sectional view of a portion of an internal combustion engine according to the eighth modification.

FIG. 13 shows a longitudinal sectional view of a piston according to the ninth modification.

FIG. 14 shows a front view of a piston according to the tenth modification.

FIG. 15 shows a front view of a piston of the different structure according to the tenth modification.

FIG. 16 shows a front view of a piston according to the eleventh modification.

FIG. 17 shows a longitudinal sectional view of a piston according to the twelfth modification.

FIG. 18 shows a longitudinal sectional view of a piston of the different structure according to the twelfth modification.

FIG. 19 shows a front view of a piston according to the thirteenth modification.

FIG. 20 shows a front view of a piston according to the fourteenth modification.

FIG. 21 shows a front view of a piston according to the fifteenth modification.

### DESCRIPTION OF THE PREFERRED EMBODIMENTS

The embodiments of the present invention are detailed with reference to the accompanying drawings. The embodiments below are the preferred embodiments of the present invention but they are not intended to limit the scope of invention and application or usage thereof.

The present embodiment relates to internal combustion engine 10 of the present invention. Internal combustion engine 10 is a reciprocating internal combustion engine where piston 23 reciprocates. Internal combustion engine 10 has internal combustion engine body 11, ignition device 12, EM-wave-emitting device 13, and control device 35. In internal combustion engine 10, the combustion cycle is repetitively executed by ignition device 12 to ignite and burn the air-fuel mixture. Internal combustion engine body

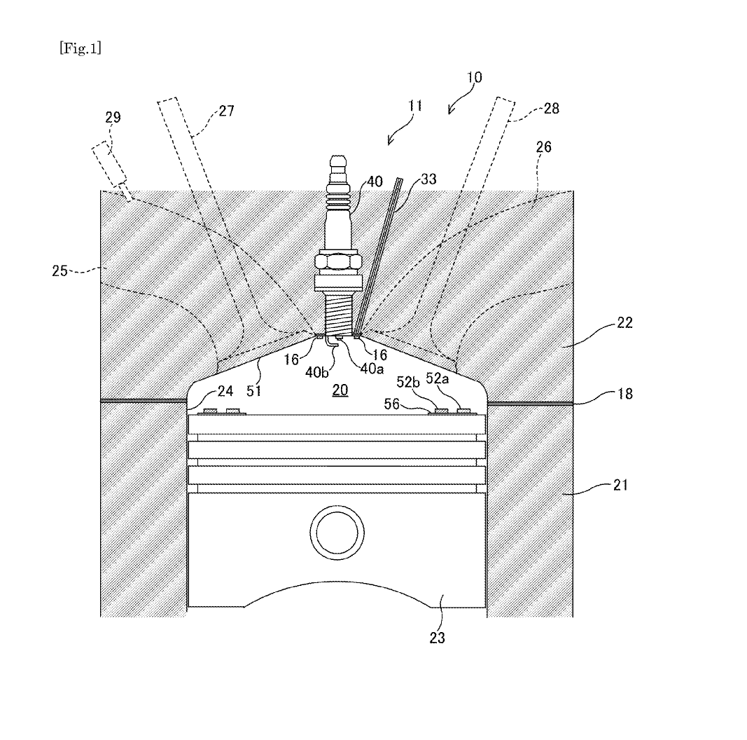

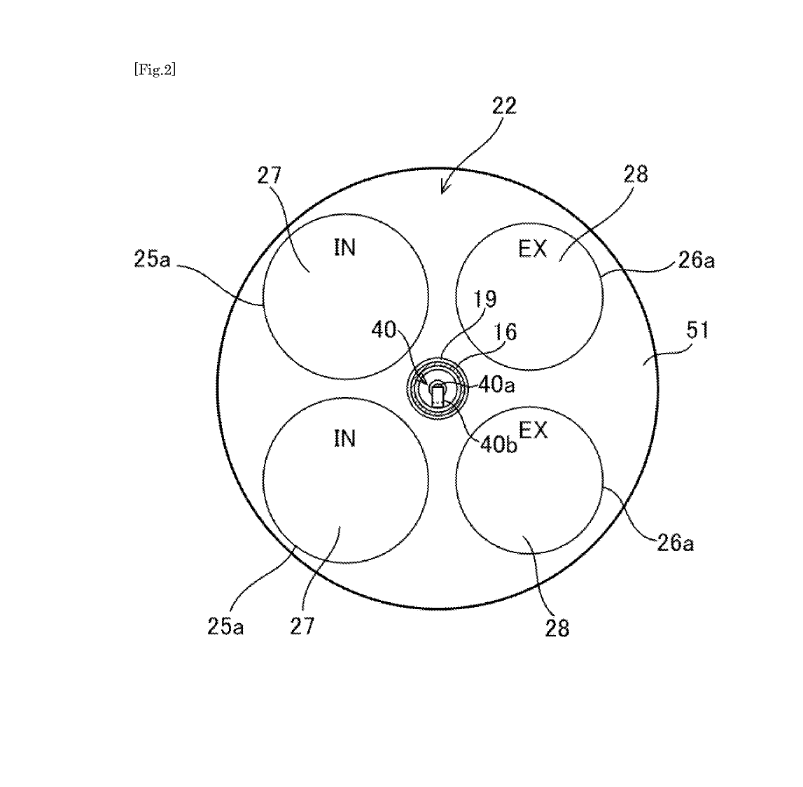

As illustrated in FIG. 1, internal combustion engine body 11 has cylinder block 21, cylinder head 22, and piston 23. Multiple cylinders 24, each having a rounded cross-section, are formed in cylinder block 21. Reciprocal pistons 23 are located in each cylinder 24. Pistons 23 are connected to a crankshaft through a connecting rod (not shown in the figure). The rotatable crankshaft is supported on cylinder block 21. The connecting rod converts reciprocations of pistons 23 to rotation of the crankshaft when pistons 23 reciprocate in each cylinder 24 in the axial direction of cylinders 24. Cylinder head 22 is located on cylinder block 21 sandwiching gasket 18 in between. Cylinder head 22 forms a circular-sectioned combustion chamber 20 together with cylinders 24, pistons 23, and gasket 18. The diameter of combustion chamber 20 is approximately half the wavelength of the microwave radiation emitted from EM-wave-emitting device 13.

A single ignition plug 40, which is a part of ignition device 12, is provided for each cylinder 24 of cylinder head 22. In ignition plug 40, a front-tip part exposed to combustion chamber 20 is placed at the center part of the ceiling surface 51 of combustion chamber 20. Surface 51 is exposed to combustion chamber 20 of cylinder head 22. The circumference of the front-tip part is circular when it is viewed from the axial direction. Center electrode 40a and earth electrode 40b are formed on the tip of the ignition plug 40. A discharge gap is formed between the tip of center electrode 40a and the tip of earth electrode 40b.

Inlet port 25 and outlet port 26 are formed for each cylinder 24 in cylinder head 22. Inlet port 25 has inlet valve 27 for opening and closing an inlet port opening 25a of inlet port 25 and injector 29, which injects fuel. Outlet port 26 has outlet valve 28 for opening and closing an outlet port opening 26a of outlet port 26. Inlet port 25 is designed so that a strong tumble flow is formed in combustion chamber 20 in internal combustion engine 10.

### Ignition Device

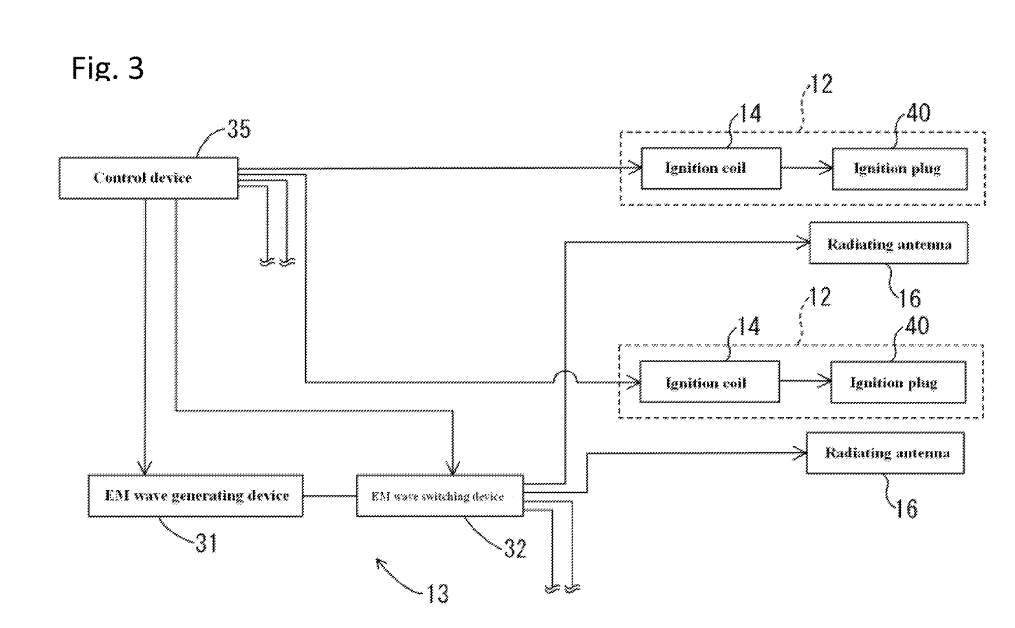

Ignition device 12 is provided for each combustion chamber 20. As illustrated in FIG. 3, each ignition device 12 has ignition coil 14 to output a high-voltage pulse, and ignition plug 40, which receives the high-voltage pulse outputted from ignition coil 14.

Ignition coil 14 is connected to a direct current (DC) power supply (not shown in the figure). Ignition coil 14 boosts the voltage applied from the DC power when an ignition signal is received from control device 35, and then outputs the amplified high-voltage pulse to center electrode 40a of ignition plug 40. In ignition plug 40, dielectric breakdown occurs at the discharge gap when a high-voltage pulse is applied to center electrode 40a. A spark discharge then occurs, and discharge plasma is generated in the discharge channel. A negative voltage is applied as the high-voltage pulse at center electrode 40a.

Ignition device 12 may have a plasma-enlarging component, which enlarges the discharge plasma by supplying electrical energy to the discharge plasma. The plasma-enlarging component may, for example, enlarge the spark discharge by supplying energy of high-frequency wave, e.g. microwave radiation to the discharge plasma. The plasma-enlarging component allows for improvements in the stability of the ignition of a lean air-fuel mixture. EM-wave-emitting device 13 may be used as the plasma-enlarging component.

### Electromagnetic Wave-Emitting Device

As illustrated in FIG. 3, EM-wave-emitting device 13 has EM-wave-generating device 31, EM-wave-switching device 32 and radiating antenna 16. One EM-wave-generating device 31 and one EM-switching device 32 are provided for each EM-wave-emitting device 13. Radiating antennas 16 are provided for each combustion chamber 20.

EM-wave-generating device 31 iteratively outputs current pulses at a predetermined duty ratio when an EM-wave-driving signal is received from control device 35. The EM-wave-driving signal is a pulsed signal. EM-wave-generating device 31 iteratively outputs microwave pulses during the pulse-width time of the driving signal. In EM-wave-generating device 31, a semiconductor oscillator generates microwave pulses. Other oscillators, such as a magnetron, may also be used instead of a semiconductor oscillator.

EM-wave-switching device 32 has one input terminal and multiple output terminals provided for each radiation antenna 16. The input terminal is connected to EM-wave-generating device 31. Each of the output terminals is connected to the corresponding radiation antenna 16. EM-wave-switching device 32 is controlled by control device 35 so that the destination of the microwaves outputted from generating device 31 switches between the multiple radiation antennas 16.

Radiation antenna 16 is located on ceiling surface 51 of combustion chamber 20. Radiation antenna 16 is ring-shaped in form when it is viewed from the front side of ceiling 51 of combustion chamber 20, and it surrounds the tip of ignition plug 40. Radiation antenna 16 can also be C-shaped when it is viewed from the front side of ceiling 51.

Radiation antenna 16 is laminated on ring-shaped insulating layer 19 formed around an installation hole for ignition plug 40 on ceiling surface 51 of combustion chamber 20. Insulating layer 19 may, for example, be formed by the spraying of an insulating material. Radiation antenna 16 is electrically insulated from cylinder head 22 by insulating layer 19. The perimeter of radiation antenna 16, i.e., the perimeter of the centerline between the inner circumference and the outer circumference, is set to half the wavelength of the microwave radiation emitted from radiation antenna 16. Radiation antenna 16 is electrically connected to the output terminal of EM-wave-switching device 32 via microwave transmission line 33 located in cylinder head 22.

In internal combustion engine body 11, multiple receiving antennas 52a and 52b resonate with the microwave radiation emitted into combustion chamber 20 from EM-wave-emitting device 13, and are provided on a zoning material defining combustion chamber 20. In this embodiment, receiving antennas 52a and 52b are located close to the outer circumference. Here, “close to the outer circumference” refers to the area outside the mid-point of the center and outer circumference of the top of piston 23. The period of time when the flame propagates to this area is referred to as the “second half of the flame propagation”. The length L of antenna 52 satisfies Eq. 1, where the wavelength of the microwave radiation is A, and n is a natural number.

L=(n×λ)/2 (Eq. 1)

Receiving antennas 52a and 52b are located close to the outer circumference of the top of piston 23, as shown in FIGS. 1 and 4. Here, “close to the outer circumference” refers to the area outside the mid-point of the center and outer circumferences of the top of piston 23.

Receiving antennas 52a and 52b are annular in shape and are concentric with the center axis of piston 23. The diameters of the two receiving antennas 52a and 52b are different, and they are located such that a double ring is formed. Receiving antennas 52a and 52b are arranged in a co-axial fashion. The first receiving antenna 52a is located at the outer side and the second receiving antenna 52b is located at the inner side. The distance x between antennas 52a and 52b satisfies Eq. 2, where λ is the wavelength of the microwave radiation emitted from radiation antenna 16 to combustion chamber 20.

λ/16≦×≦2λ/3 (Eq. 2)

Receiving antennas 52a and 52b are located on insulating layer 56 formed on the top of piston 23, i.e., the combustion-chamber-side surface of the zoning material. Receiving antennas 52a and 52b are electrically insulated from piston 23 using insulating layer 56, and are provided in an electrically floating state.

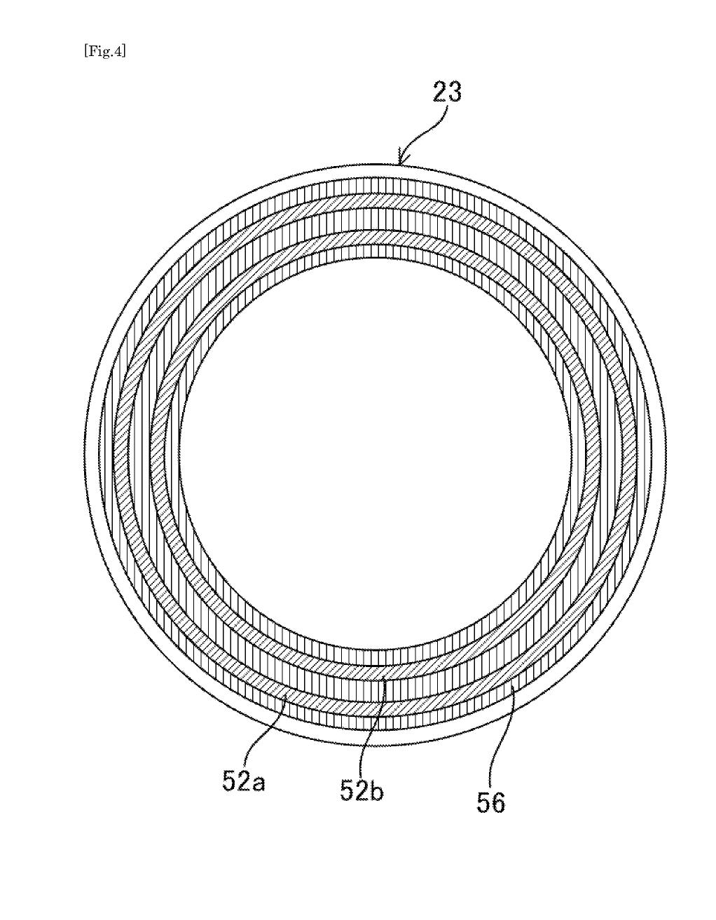

The number of receiving antennas 52 provided on the top of piston 23 as shown in FIG. 5 may be one.

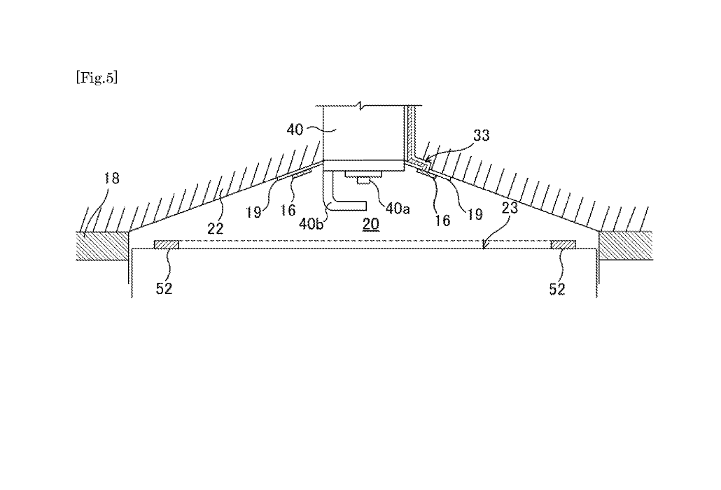

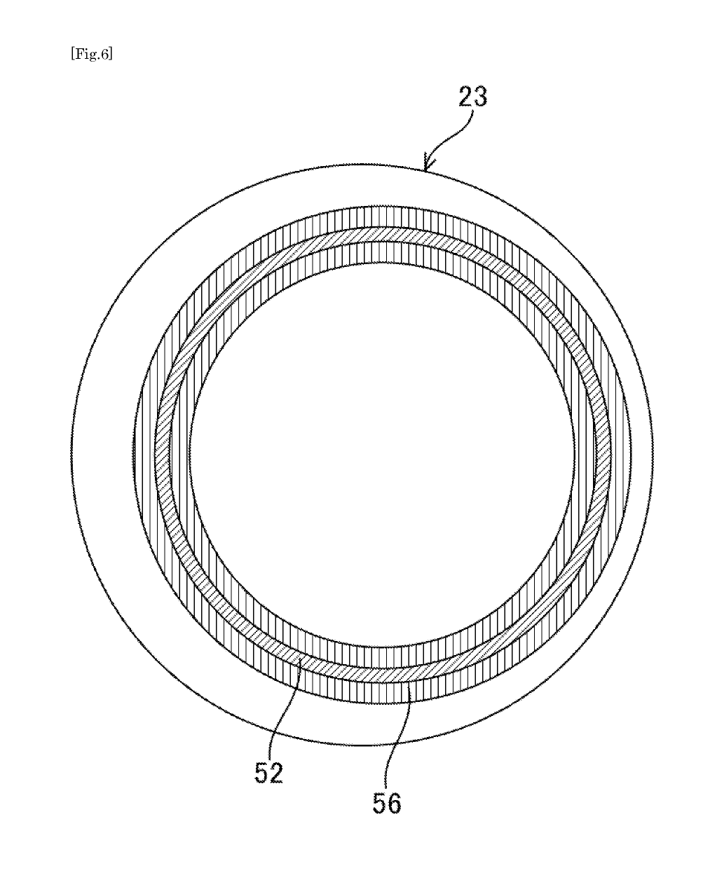

Regardless of the number of receiving antennas 52 on piston 23, the center of antenna 52 may be shifted from the center axis of piston 23. For example, the center of receiving antenna 52 may be shifted to the exhaust side from the center of piston 23, as shown in FIG. 6. In such a case, the flame front passes the exhaust side and the intake side of receiving antenna 52 almost simultaneously during the microwave radiation period.

Annular receiving antennas 52a and 52b do not have to be allocated concentrically. For example, the center of antenna 52b located inner side may be shifted toward intake-side opening 25a. In this case, the distance between the antennas 52a and 52b becomes shorter as approaching the intake-side opening 25a. This increases the strength of the electric field at intake-side opening 25a.

### Operation of the Control Device

Here, the operation of control device 35 will be described. Control device 35 executes a first operation directing ignition device 12 to ignite the air-fuel mixture, and a second operation directing EM-wave-emitting device 13 to emit microwaves following the ignition of the air-fuel mixture in one combustion cycle for each combustion chamber 20.

In other words, control device 35 executes the first operation immediately prior to piston 23 reaching top dead center (TDC). Controller 35 outputs an ignition signal as the first operation.

As described above, a spark discharge occurs in the discharge gap of ignition plug 40 in ignition device 12 when an ignition signal is received. The air-fuel mixture is ignited by the spark discharge. When the air-fuel mixture is ignited, a flame grows from the igniting position of the air-fuel mixture in the center part of combustion chamber 20 to the wall face of cylinder 24.

Control device 35 executes the second operation after the ignition of the air-fuel mixture, i.e., at the start of the second half of the flame propagation. Control device 35 outputs an EM-wave-driving signal as the second operation.

EM-wave-emitting device 13 repeatedly outputs microwave pulses from radiating antenna 16 when the EM-wave-driving signal is received. Microwave pulses are emitted repetitively throughout the second half of the flame propagation.

The microwave pulses resonate in each receiving antenna 52. In the area close to the outer circumference of combustion chamber 20, where the two receiving antennas 52 are located, an intense electric field is formed during the second half of the flame propagation. The propagation speed of the flame increases due to absorption of the microwave radiation when the flame passes the intense electric field.

### Advantage of the Embodiment

In this embodiment, an intense electric field is formed close to the outer circumference of combustion chamber 20 during flame propagation. This allows for an increase in the propagation speed of the flame close to the outer circumference of combustion chamber 20.

### Modification 1

In the first modification, EM-wave-emitting device 13 is provided such that plasma is generated by microwave radiation emitted from radiation antenna 16. The energy per unit time of the microwave radiation from EM-wave-generating device 31 is set such that microwave plasma is generated near each receiving antenna 52 via absorption of the microwave radiation emitted from radiation antenna 16.

EM-wave-emitting device 13 continuously emits microwave pulses throughout the second half of the flame propagation period. Plasma is generated near each receiving antenna 52 during the second half of the flame propagation period. In the area where the plasma is generated, active species, such as OH radicals, are produced. The propagation speed of the flame thereby increases in this area.

EM-wave-emitting device 13 may repeatedly emit microwave pulses during the first half of the flame propagation period. In such a case, the microwave plasma is generated by the microwave radiation during the first half of the flame propagation period. The flame propagation speed in the area close to the circumference of combustion chamber 20 increases due to the production of active species in the first half of the flame propagation period.

Internal combustion engine 10 may have a discharge device so that discharge occurs close to the circumference of combustion chamber 20 in order to reduce the power of the microwave radiation emitted from radiation antenna 16. For example, the discharge device may cause the discharge by applying a high-voltage pulse between a pair of electrodes. In this case, one electrode (referred to as the first electrode) is located on cylinder head 22 and a second electrode is located on the upper surface of piston 23. The second electrode is located in the top portion of the convex portion of the top side of piston 23 so that the distance between the first and second electrodes may be reduced.

### Modification 2

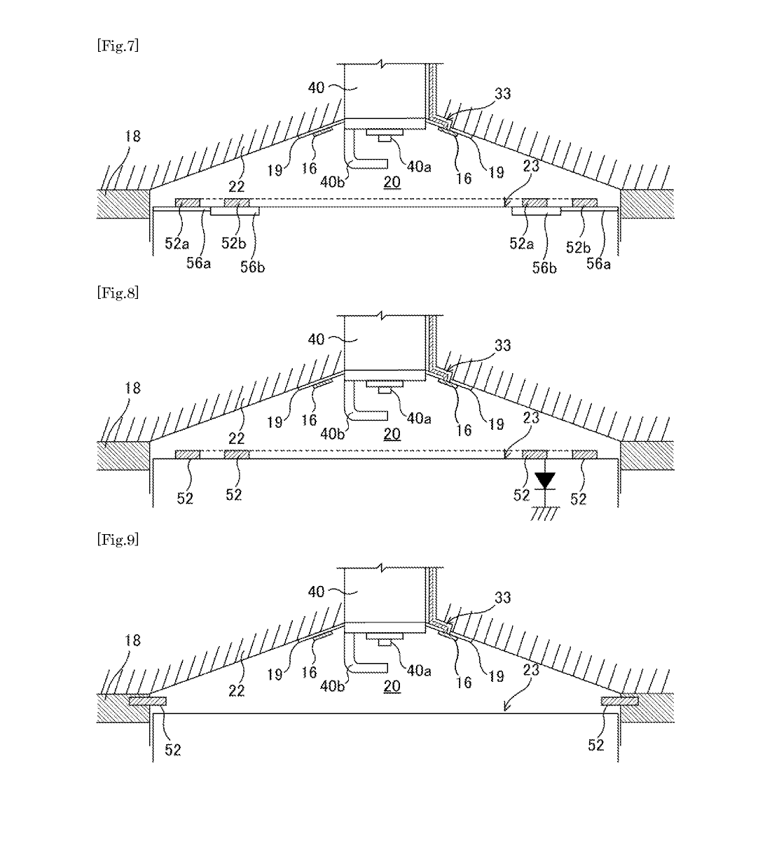

In the second modification, multiple receiving antennas 52 are located concentrically on the top surface of piston 23, as shown in FIG. 7. Each receiving antenna 52 has different resonance frequencies. EM-wave-generating device 31 varies the frequency of the emitted microwave radiation such that receiving antenna 52 located at inner portion of the ring resonates first during the flame propagation. A strong electric field is sequentially formed in the neighborhood of receiving antennas 52. The propagation speed of the flame increases near each receiving antenna 52.

In the second modification, inner-side insulation layer 56b is laminated with second receiving antenna 52b, and therefore is thicker than outer-side insulation layer 56a, which is laminated with first receiving antenna 52a.

### Modification 3

In the third modification, receiving antenna 52 is grounded via a diode, as shown in FIG. 8. In this embodiment, only second receiving antenna 52b is grounded using a diode. However, either only first receiving antenna 52a or both antennas 52a and 52b may be grounded using a diode.

The third modification allows inducing an ion of polarity opposite to second receiving antenna 52b, that is in a flame, due to fact the signal in grounded antenna 52b may be a DC signal. The propagation speed of the flame is thereby increased.

### Modification 4

In the fourth modification, annular receiving antenna 52 is located in the inner part of gasket 18, as shown in FIG. 9. FIG. 9 shows single annular receiving antenna 52 provided in gasket 18. Instead, multiple annular antennas 52 may be provided at intervals in the thickness direction of gasket 18. Receiving antenna 52 may be provided on the top surface of piston 23 in addition to those in gasket 18.

### Modification 5

In the fifth modification, receiving antenna 52 is located on the inner side of a constricted flow area. The microwave plasma generated near receiving antenna 52 thereby moves inside due to the constricted flow. Activated species produced in the plasma area are thereby diffused.

### Modification 6

In the sixth modification, receiving antenna 52 is located in insulating layer 56, as shown in FIG. 10. Insulating layer 56 may, for example be formed of a ceramic material.

In the cross-sectional surface of insulating layer 56, where receiving antenna 52 is installed, coating layer 56a is formed from an insulating material. Receiving antenna 52 and supporting layer 56b are also formed from an insulating material and are stacked in sequence from the side of combustion chamber 20. Supporting layer 56 is laminated on a zoning material, such as pistons 23.

In the sixth modification, coating layer 56a is thinner than supporting layer 56b. This prevents a decrease in the electric field at the side of combustion chamber 23 when receiving antenna 52 is protected using the insulating material.

### Modification 7

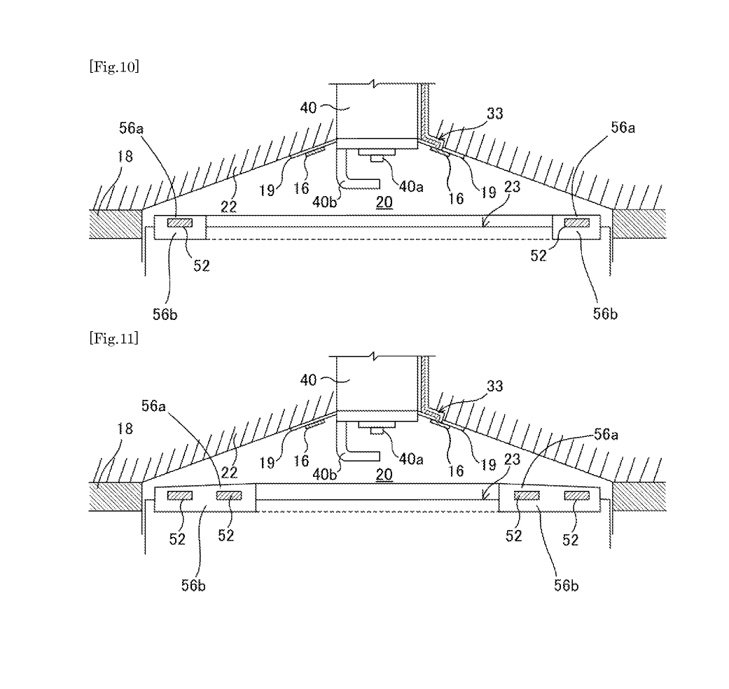

In the seventh modification, two receiving antennas 52 are installed on the top of piston 23, as shown in FIG. 11. The receiving antennas 52 are covered with coating layer 56a. The thickness of coating layer 56a is reduced going from the inside to the outside of combustion chamber 20. On coating layer 56a, which coats the receiving antennas 52, the electric field increases at the outer side compared with the inner side when microwave radiation is emitted into combustion chamber 20. This allows for an increase in the propagation speed of the flame at the outer side of combustion chamber 20.

### Modification 8

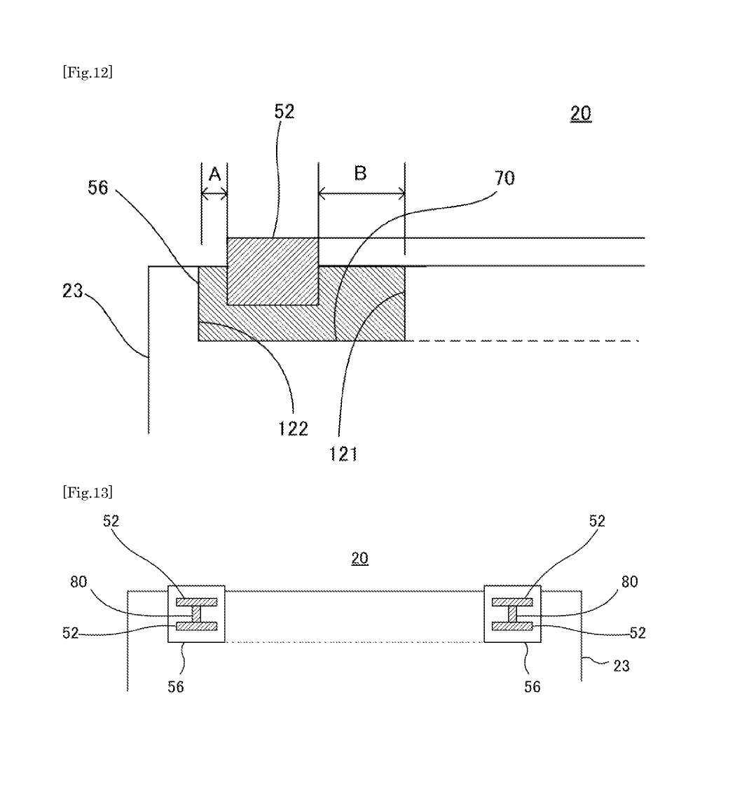

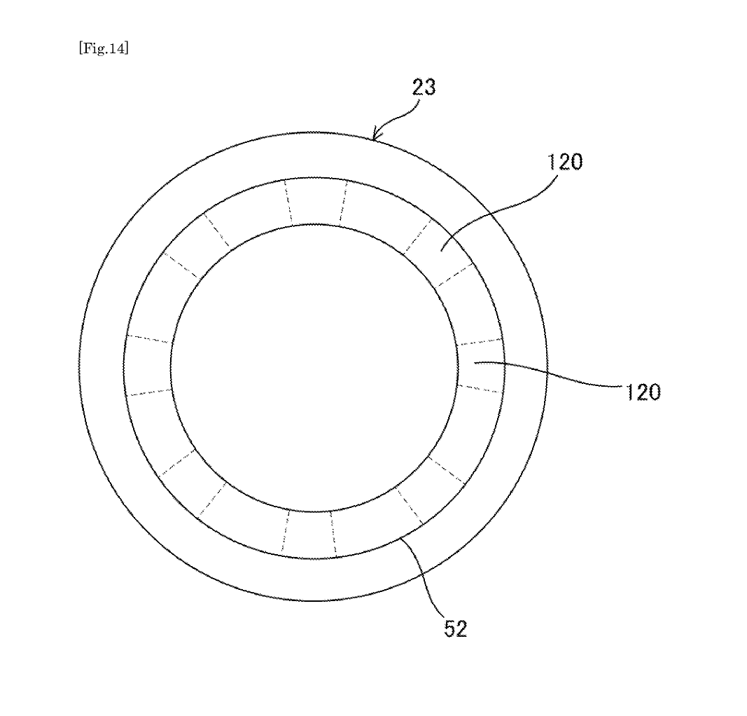

In the eighth modification, insulation layer 56 is located in trench 70 formed on piston 23 (the zoning material) along the circumference of combustion chamber 20. As shown in FIG. 12, receiving antenna 52 is elongated along trench 70 between inner wall 121 and outside wall 122 of trench 70. When the microwave radiation is emitted from radiation antenna 16, an electric field is formed in the vertical direction in the inner side and outer side of receiving antenna 52 between antenna 52 and wall face 121 or 122. This allows for an increase in the propagation speed of the flame via the electric field near receiving antenna 52.

In the eighth modification, the distance A between the outer circumference of receiving antenna 52 and outer wall 122 of trench 70 is shorter than the distance B between the inner circumference of receiving antenna 52 and inner wall 121 of trench 70. This allows for an increase in the propagation speed of the flame front near the wall of combustion chamber 20 because the electric field is stronger at the outer side than the inner side of receiving antenna 52.

### Modification 9

In the ninth modification, two ring-shaped receiving antennas 52 are located in ring-shaped insulation layer 56, which is laminated on piston 23 (the zoning material) at intervals in the thickness direction of insulation layer 56, as shown in FIG. 13.

In insulation layer 56, two receiving antennas 52 are connected to each other, at least at one location, using pressure equalizing conductor 80, whereby conductor 80 equalizes the pressure at the connection. In the ninth modification, conductor 80 is located between two receiving antennas 52, at intervals of the quarter wavelength of the microwave radiation in the circumferential direction of receiving antenna 52.

Ring-shaped receiving antennas 52 may be allocated in gasket 18 in a multilayer configuration. Receiving antennas 52 are provided in the thickness direction of gasket 18, which is formed of insulating materials at intervals. Pressure equalizing conductor 80 may be also used in such a case.

### Modification 10

In the tenth modification, annular receiving antenna 52 has a different cross-sectional area in the conducting material that constitutes receiving antenna 52 in the circumferential direction. In this modification, convex portion 120 is provided in receiving antenna 52 such that portion 120 protrudes toward piston 23 at regular intervals. The cross-sectional surface area of the conductor varies in convex portion 120. In receiving antenna 52, the thickness of convex portion 120 is large compared to the separation between convex portions 120. The tenth modification allows for a particular electric field distribution to form on receiving antenna 52 when microwave radiation is emitted from radiation antenna 16.

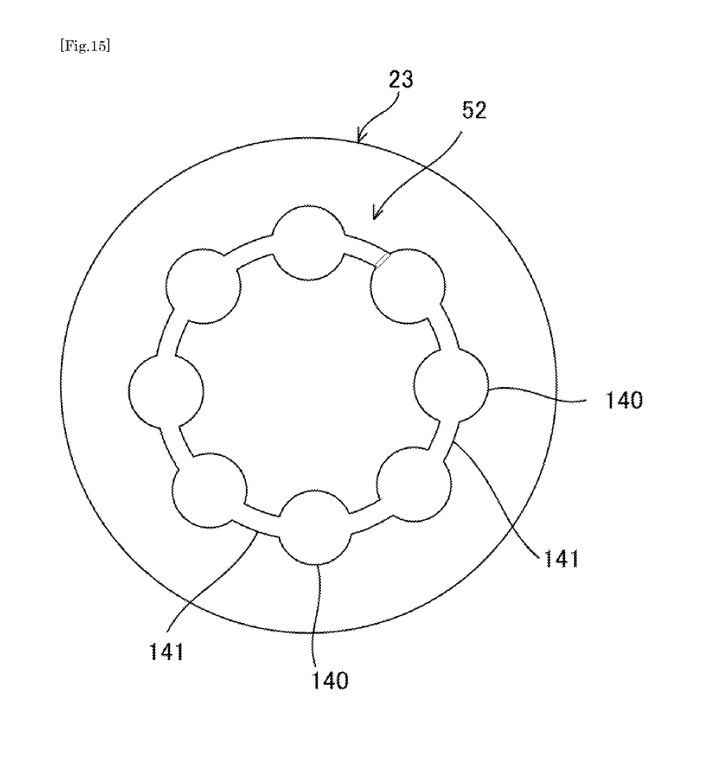

The cross-sectional surface area of the conductor may be altered by varying the width of receiving antenna 52. For example, receiving antenna 52 may be formed in a gear-like fashion when viewed from above. The cross-sectional surface area of the conductor may be varied by allocating disc portion 140 having a diameter larger than the width of adjacent portion 141 in receiving antenna 52, as shown in FIG. 15. The cross-sectional surface area of the conductor constituting antenna 52 may be varied in intake side-opening 25a.

### Modification 11

In the eleventh modification, multiple curved portions 85 are formed on the outer circumference of annular receiving antennas 52 to concentrate the electric field, as shown in FIG. 16. The electric field is concentrated at curved portions 85 of receiving antenna 52 when the microwave radiation is emitted from radiation antenna 16. This allows for the generation of plasma with reduced energy consumption.

In this modification, curved portions 85 are provided only at the sides of inlet opening 25. However, curved portions 85 may also be provided at other locations. For example, curved portions 85 may be provided on the inner side of ring shaped receiving antenna 52.

### Modification 12

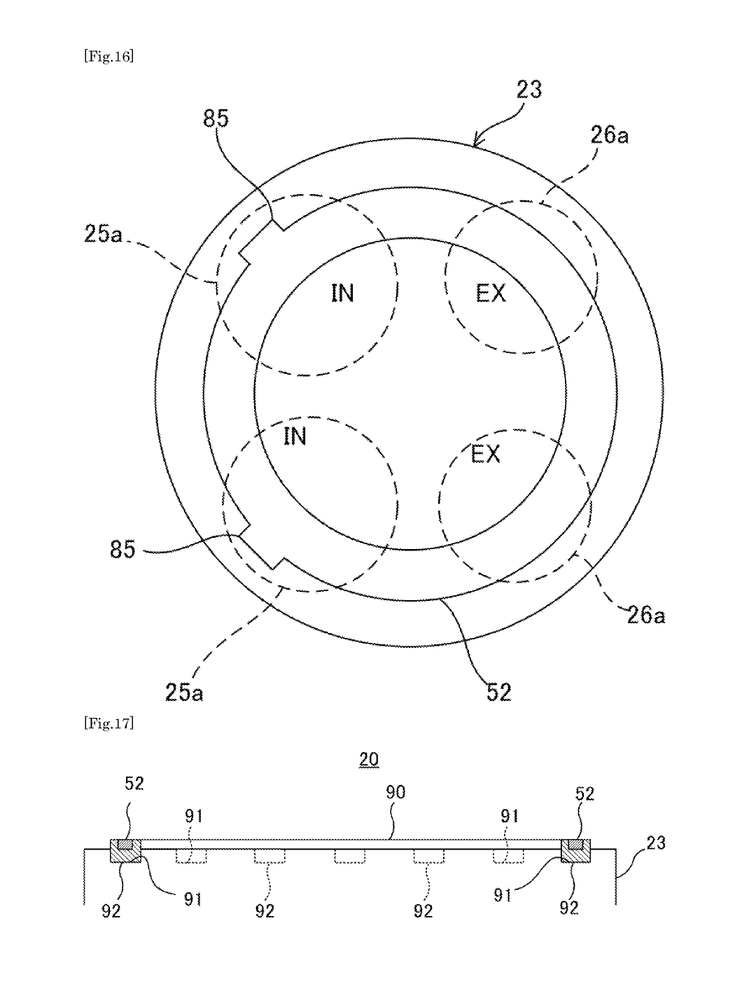

In the twelfth modification, receiving antenna 52 is provided in ceramic insulation material 90 laminated on the top surface of piston 23, for example, as shown in FIG. 17. Multiple convex parts 92 that engage to concave part 91 formed on the top surface of piston 23 are formed in insulation material 90 at the side of piston 23. This modification prevents insulation material 90 from peeling off from piston 23.

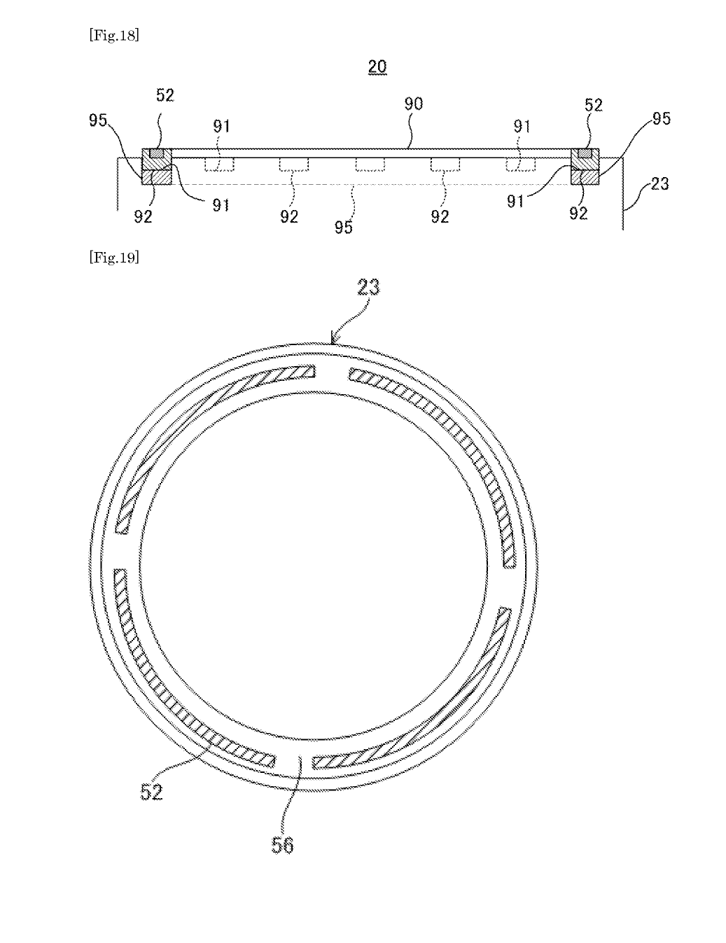

Cushioning layer 95, which is softer than piston 23, may be installed between piston 23 and insulation material 90, as shown in FIG. 18. Cushioning layer 95 may be formed of a ductile metal, such as gold. Cushioning layer 95 may prevent damage to insulation material 90 due to knocking.

### Modification 13

The annular antenna may be divided into lengths of half the wavelength of the microwave radiation, as shown in FIG. 19.

When the frequency of the EM radiation emitted from radiation antenna 16 is 2.45 GHz, the wavelength (in vacuum) is λ=12.2 cm since the wavelength is obtained by dividing the light speed (3×10⁸) by the frequency. Thus, the length of receiving antenna 52 should be multiples of 6.1 cm. When receiving antenna 52 is designed as an annular antenna, as shown in FIG. 4, the diameter should be a multiple of 1.95 cm. In other words, the sensitivity of the receiving antenna may suffer when the diameter is not a multiple of 1.95 cm.

Thus, receiving antennas with high sensitivity may be arranged at arbitrary radial locations when receiving antenna 52 is a multiple of half wavelengths of the microwave radiation, as shown in FIG. 19. This allows for an intense electric field to be induced at arbitrary radial locations using microwave radiation.

### Modification 14

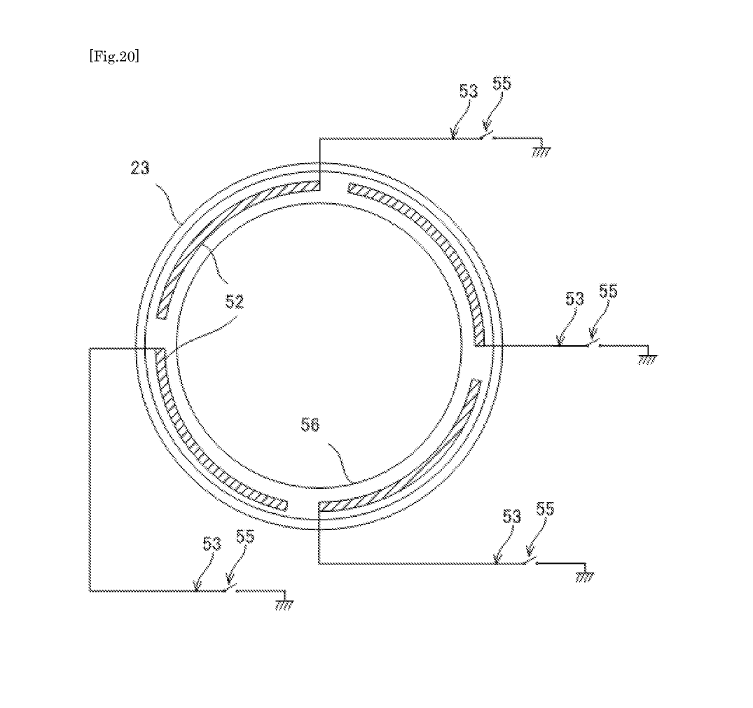

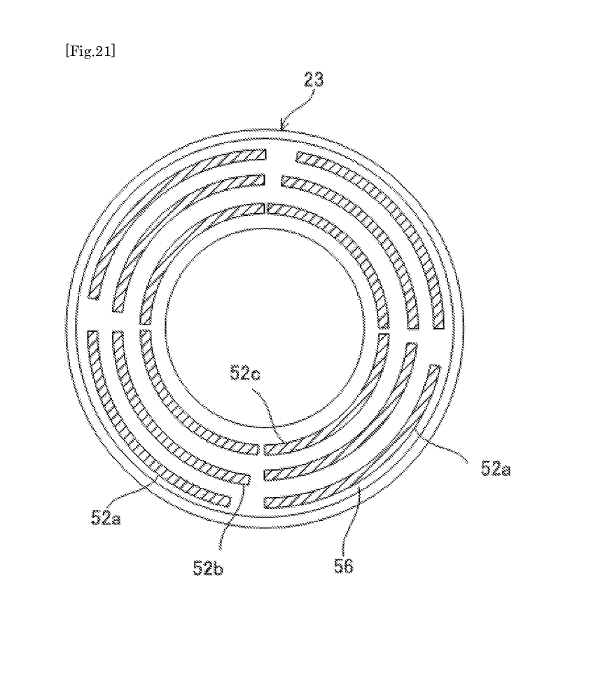

One end of each receiving antenna 52 may be electrically connected to ground via switch 55, as shown in FIG. 20. The length of each receiving antenna 52 should be multiples of half the wavelength of the microwave radiation, and receiving antenna 52 should be insulated from piston 23 using insulation layer 56, for example, as shown in FIG. 19.

In this example, one end of receiving antenna 52 is connected to the outer wall of piston 23 when switch 55 is closed. Antenna 52 is thereby grounded. In this case, the grounded part becomes the fixed end, and the other side becomes the floating end. In such a configuration, the sensitivity is a maximum when the length of the antenna is an odd multiple of the quarter wavelength. The length of receiving antenna 52 is half the wavelength of the microwave radiation; therefore, the induced current from the microwave radiation emitted from radiating antenna 16 is small in receiving antenna 52. Receiving antenna 52 is thereby switched off.

When switch 55 is closed, receiving antenna 52 becomes floating (i.e., electrically insulated from piston 23). Both sides of receiving antenna 52 thereby become floating ends. In this case, the receiving sensitivity becomes a maximum when the length of the antenna is a multiple of the half wavelength. Receiving antenna 52 switches on since the length of receiving antenna 52 is the half wavelength of the microwaves.

Receiving antenna 52 can therefore be switched by opening or closing switch 55.

The microwave radiation from antenna 16 is concentrated close to receiving antenna 52, which is switched on. The electric field therefore increases near the antenna. This allows control over the intensity of the electric field at an arbitrary location in the combustion chamber, and may therefore result in an enlargement of the plasma at an arbitrary position in the combustion chamber.

### Modification 15

As shown in FIG. 21, receiving antennas 52, which are of the same length (i.e., half the wavelength of the microwave radiation) may be located in different radial positions on piston 23. For example, four receiving antennas 52a may be arranged at the outer circumference. At the inner side, four receiving antennas 52b having the same length as antenna 52a, but with a smaller radius of curvature, may be arranged. Furthermore, four receiving antennas 52c having the same length as antennas 52a, but with a radius of curvature smaller than antennas 52b, may be arranged at the inner side. This allows for an intensification of the electric field at the various radial locations in combustion chamber 20.

### Other Embodiments

Other embodiments may be contemplated.

Center electrode 40a of ignition plug 40 may also function as a radiation antenna. Center electrode 40a of ignition plug 40 is connected electrically with an output terminal of a mixing circuit. The mixing circuit receives a high-voltage pulse from ignition coil 14 and microwaves from EM-wave switch 32 from separate input terminals, and outputs both the high-voltage pulse and the microwaves from the same output terminal.

An annular radiation antenna 16 may be provided in gasket 18. An annular receiving antenna 52 may be provided on top of piston 23.

Receiving antenna 52 may be provided on the inner-wall surface of cylinder 24.

In the above embodiment, the following steps may be executed in sequence to fix a heat-resistant dielectric substance, such as a ceramic material, on which receiving antenna 52 is provided. (i) Spraying an organic mask onto receiving antenna 52; (ii) thermal spraying of aluminum toward the dielectric substance; (iii) peeling this aluminum layer on receiving antenna 52 together with the organic mask; and (iv) fixing the dielectric substance to piston 23 via the aluminum layer. In this case, the planar form of receiving antenna 52 and the dielectric substance may be annular or such a shape whereby the antenna is curved with a small radius of curvature.

Radiation antenna 16 may be termed the “first antenna” and receiving antenna 52 can be termed the “second antenna”.

### INDUSTRIAL APPLICABILITY

As described above, the present invention is useful for an internal combustion engine that promotes the combustion of an air-fuel mixture using EM radiation.

1. An internal combustion engine including an internal combustion engine body formed with a combustion chamber, and an ignition device igniting an air-fuel mixture in the combustion chamber, wherein repetitive combustion cycles including ignition of the air-fuel mixture by the ignition device and combustion of the air-fuel mixture, are executed, the internal combustion engine comprising:
an electromagnetic (EM) wave-emitting device that emits EM radiation to the combustion chamber;
a plurality of receiving antennas located on the outer circumference of the zoning material that defines the combustion chamber; the antennas resonate with the EM radiation emitted to the combustion chamber from the EM-wave-emitting device; and
a control means which controls the EM-wave-emitting device such that the radiating antenna emits EM radiation to the combustion chamber while a flame caused by ignition of the air-fuel mixture propagates.

2. The internal combustion engine of claim 1, wherein
a plurality of receiving antennas is located on the zoning material.

3. The internal combustion engine as claimed in claim 1, wherein
the receiving antenna is located on an insulating layer laminated on the combustion-side surface of the zoning material.

4. The internal combustion engine as claimed in claim 3, wherein
a coating layer formed of an insulating material, the receiving antenna, and a supporting layer formed of an insulating material are laminated in sequence from the side of the combustion chamber at the cross-sectional surface of the insulating layer where receiving antenna is installed and
the thickness of the coating layer is less than that of the supporting layer.

5. The internal combustion engine as claimed in claim 4, wherein
the thickness of the coating layer reduces going from the inside to the outside of the combustion chamber.

6. The internal combustion engine as claimed in claim 3, wherein
an insulating layer is located on a grooved portion formed on the zoning material along the circumferential direction of the combustion chamber, and
the receiving antenna extends along the grooved portion between the inner surface and the outer surface of the insulating layer.

7. The internal combustion engine as claimed in claim 6, wherein
the distance between the outer circumference of the receiving antenna and the outer wall of the grooved portion is shorter than the distance between the inner circumference of the receiving antenna and the inner wall of the grooved portion.

8. The internal combustion engine as claimed in claim 3, wherein
a plurality of receiving antennas is located on the insulating layer at intervals in the thickness direction.

9. The internal combustion engine as claimed in claim 8, wherein
the plurality of receiving antennas is connected to at least one connection point using a pressure-equalizing conductor to equalize the voltage.

10. The internal combustion engine as claimed in claim 1, wherein
the receiving antennas are located close to the outer circumference of the piston forming a zoning material.

11. The internal combustion engine as claimed in claim 1, wherein
the receiving antennas are located on a gasket that forms a zoning material.

12. The internal combustion engine as claimed in claim 10, wherein
the annular receiving antennas are formed in the circumferential direction of the combustion chamber.

13. The internal combustion engine as claimed in claim 10, wherein
the annular receiving antennas are formed in the circumferential direction of the combustion chamber, and
the plurality of annular receiving antennas with different diameters is located on the upper portion of the piston.

14. The internal combustion engine as claimed in claim 12, wherein
the cross-sectional area of the conducting material constituting the annular receiving antenna is varied along the circumferential direction.

15. The internal combustion engine as claim 12, wherein,
a plurality of curved portions that concentrate the electric field is formed at the inner circumference or outer circumference of the annular receiving antenna.

16. The internal combustion engine as claimed in claim 10, wherein
the receiving antenna is located on the insulating material laminated on the top-surface of the piston, and
a convex portion fitting to a concave portion formed on the circumference or outer circumference of the ring-shaped receiving antenna.

17. The internal combustion engine as claimed in claim 10, wherein,
the radiating antenna is located on a cylinder head.

18. The internal combustion engine as claimed in claim 2, wherein
the receiving antenna is located on an insulating layer laminated on the combustion-side surface of the zoning material.

19. The internal combustion engine as claimed in claim 4, wherein
an insulating layer is located on a grooved portion formed on the zoning material along the circumferential direction of the combustion chamber, and
the receiving antenna extends along the grooved portion between the inner surface and the outer surface of the insulating layer.

20. The internal combustion engine as claimed in claim 5, wherein
an insulating layer is located on a grooved portion formed on the zoning material along the circumferential direction of the combustion chamber, and
the receiving antenna extends along the grooved portion between the inner surface and the outer surface of the insulating layer.
